(19) United States
(12) Patent Application Publication
(10) Pub. No.: US 2017/0300116 A1
(43) Pub. Date: Oct. 19, 2017

(54) SYSTEM AND METHOD FOR PROVIDING TACTILE FEEDBACK FOR USERS OF VIRTUAL REALITY CONTENT VIEWERS

(71) Applicant: Bally Gaming, Inc., Las Vegas, NV (US)

(72) Inventors: Martin LYONS, Henderson, NV (US); Rolland STEIL, Las Vegas, NV (US); Marvin A. HEIN, JR., Las Vegas, NV (US); Jeremy Michael HORNIK, Chicago, IL (US); Bryan M. KELLY, Alamo, CA (US); Gabriel BARON, Henderson, NV (US)

(21) Appl. No.: 15/487,798

(22) Filed: Apr. 14, 2017

Related U.S. Application Data
(60) Provisional application No. 62/323,301, filed on Apr. 15, 2016.

(51) Int. Cl. G06F 3/01; G06T 13/40; G06T 11/60; G06F 3/02; G06F 3/042; A63F 13/24; A63F 13/40; H04N 21/478; A63F 13/28; G06F 3/0488

(52) U.S. Cl. CPC G06F 3/016; H04N 21/4781; G06T 13/40; G06T 11/60; G06F 3/02; A63F 13/28; G06F 3/0425; A63F 13/24; G06F 3/012; A63F 13/40; A63F 2300/8082; G06F 3/04883

(57) ABSTRACT

A gaming system and method for integrating tactile feedback into a virtual reality environment as viewed by a virtual reality viewer is disclosed. A physical object, which may be a physical button panel, such as a button panel printed on paper, dice, playing cards, coins or chips, a floor or any other tangible object, has a view thereof incorporated into the virtual reality environment. When the user touches the physical object, the touch gesture is captured and processed by the system to interpret the touch gesture as an input. The physical object may include a printed, projected or touch screen panel, a hand-held object, a portion of a gaming machine cabinet, a table tops, a floor and the like.

### RELATED APPLICATIONS

This application is a non-provisional application of U.S. Provisional Application 62/323,301 filed Apr. 15, 2016, hereby incorporated by reference in its entirety for all purposes.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to virtual reality viewers, and methods for providing touch, tactile, feedback to users using the virtual reality viewer for interacting with virtual reality content. More particularly it relates to integrating touch feedback from active and inert touch interfaces in a virtual reality environment. Still more particularly it relates to systems and method for providing touch, tactile, feedback to users using a virtual reality viewer for interacting with virtual reality gaming content.

### BACKGROUND OF THE INVENTION

Virtual reality consoles, i.e. viewers, are known for providing an immersive interactive video experience to a user. These viewers typically are worn on the user's head and position a stereo-optical display for the user to view. The content is presented in an auto-stereo, three-dimensional rendition. Virtual reality content can be created video content like interactive games and can be pre-recorded or live video streams captured by virtual reality capable cameras which can capture a 360° view of the environment. The content may be provided to the viewer through a wireless network, e.g. ultra-high frequency band assigned for mobile cellular communication such as 2G, 3GPP and 4G, WiFi or the like. The viewers can include location and position sensors as well as gyroscopes and accelerometers such that the content is rendered based upon the user turning or dipping their head. Katz et al, US Pub. App. 2015/0193949 filed Jan. 5, 2015 and titled “Calibration of Multiple Rigid Bodies in a Virtual Reality System”, the disclosure of which is incorporated by reference, discloses such a viewer and supporting system. Perry, WO 2014/197230A1 filed May 23, 2014 and titled “Systems and Methods for Using Reduced Hops to generate Virtual-Reality Scene Within a Head Mounted System”, the disclosure of which is incorporated by reference, discloses a gaming virtual reality (VR) headset using a handheld controller to provide user input. The head mounted display may include a forward looking digital camera to capture images of hand or finger gestures to provide user input and to provide real environmental context which may be considered in the VR rendition.

In environments where a VR viewer does not have a handheld “wired” or wireless controller, and instead relies on hand or finger gestures in front of the viewer and captured by the forward looking camera, there is no tactile feedback. For example, if the VR content requires the user to provide a button press or a finger slide input, a captured gesture in the air in front of the viewer does not provide a physical touch feedback. Further where there are several buttons from which one must be selected to depress, the confirmatory tactile feedback of a physical button press is not present. With specific reference to gaming and physical gaming machines which have numerous selection buttons, a VR rendition of the gaming machine would not provide the player with the touch, tactile, feedback associated with a button selection and press or touch. Without a wired or wireless active button panel, the tactile feedback cannot be had. It would be advantageous to provide a system and method where a physical, inactive, communicatively inert, button panel can be synchronize with a VR viewer to provide VR rendered buttons corresponding to buttons on the physical panel and to detect, through gesture recognition, a touch at the physical button. By communicatively inert what is meant is that the button panel is not connected by wired or wireless communication to a network or system as would be a computer keyboard or wired/wireless controller and which provide user inputs. The viewer recognizes the touch gesture and the touch at the physical panel provides the touch feedback to the user. According to this arrangement the physical panel can be a printed button panel to lay on a rigid surface such as a desk top, a projected button panel or an inert button panel with depressible buttons. It would be advantageous to use the same approach to finger “slide”, touch pointer or touch gesture inputs to provide touch feedback to the user. In this fashion tactile feedback can be provided without connected keyboards or controllers.

### SUMMARY OF THE INVENTION

According to one aspect of the present invention, a system for providing tactile feedback for a user of a virtual reality headpiece viewer is provided where the system includes one or more servers to package and control virtual reality (“VR”) content delivered to the viewer responsive to user inputs and a transceiver to deliver the content to the viewer and receive and transmit inputs from the user to the one or more servers through a communication network. The system further includes a physical button panel for buttons associable with different user inputs, the user touch at a button providing a tactile feedback to the user where the panel is, with respect to user touches, communicatively inert. A viewer video camera captures real-time image data of the panel. A controller at the viewer and/or the one or more servers receives the image data and transmits the data to the one or more servers. The one or more servers and/or controller synchronize the virtual reality content for defining virtual buttons to substantially correspond with the positions of one or more physical button locations described on the panel and allocate a virtual reality input function to each virtual button. The viewer forward looking camera captures a user's touch gesture at the physical button on the panel for generating an input signal associated with the button and its allocated input function which is provided as one or more signals to the transceiver. The viewer controller and/or servers based upon the camera data signals integrate a view of the physical panel into the virtual reality environment such that the user may recognize and touch the physical panel to obtain the tactile feedback while the camera interprets the touch gesture as an input for controlling one or more feature associated with the virtual reality content.

Where the viewer includes position sensors to sense the direction and angle of view to include the physical button panel, perhaps resting on a desktop, the controller and/or one or more servers are configured to render into the virtual reality environment the corresponding view of the button panel such as perspective and orientation as would be expected in the physical world. Thus when a user tips their head to bring the physical button panel into view, the controller and/or servers in real time render a virtual reality version of the button panel into the virtual reality environment viewed by the user.

In an embodiment the button panel could be printed, or a video display with or without haptic feedback (as described in Rosenberg et al, U.S. Pat. No. 7,982,720 issued Jul. 19, 2011 and titled “Haptic Feedback for Touchpads and other Touch Controls” and Kelly et al, US Pub App 2014/0235320A1 filed Apr. 15, 2014 and titled “Dynamic Palpable Controls for a Gaming Device”, the disclosures of which is incorporated by reference), or include depressible buttons such as an elastomeric button panel.

There is also set forth a system for providing tactile feedback for a player of a virtual reality headpiece viewer for playing a virtual gaming device such as devices commonly referred to as a slot machines where the system includes one or more servers to package and control virtual reality gaming content for delivery to the player responsive to user inputs and a transceiver to deliver the content to the viewer and receive and transmit inputs from the player. The system further includes a physical button panel for buttons associable with different user inputs, the player touch at a button providing a tactile feedback to the player where the panel is, with respect to player touches, communicatively inert. For example a player may touch a button to prompt play of the gaming device, change wagers or change wagering propositions, e.g. how many pay lines to wager upon, or provide sliding gestures to spin a wheel or reel as part of the virtual reality game environment. A video camera captures real-time image data of the physical button panel and the player's touch. The video camera may be mounted to the headpiece. A controller at the headpiece and/or the one or more servers receives the image data and transmits the data to the one or more servers. The one or more servers and/or controller synchronize the virtual reality content for defining player observed virtual buttons to substantially correspond with the positions of one or more physical buttons locations on the physical button panel, allocate a virtual reality input function to each virtual button and determine a player's touch at a physical button for generating an input signal associated with the button and its allocated input function and provide the signal to the transceiver. The viewer controller and/or servers based upon the camera data integrate a view of the physical panel into the virtual reality environment such that the player may touch the physical panel to obtain the tactile feedback while the camera interprets the touch gesture as an input for controlling one or more features associated with the virtual reality content.

Related to the foregoing where the player is in a casino environment, a player virtual reality station may be provided which includes a cash validator and ticket validator and printer which are associated with the physical button panel to enable the player to establish credits for wagering and to receive an physical instrument when cashing out credits as is provided in current casino environments. Additionally or alternatively the headpiece may communicate with a credit account for downloading value for gaming credits.

In an embodiment the physical button panel may include electromagnetic beacons or visual beacons to enable the controller and/or one or more servers to recognize the location, orientation, type or configuration, size and/or shape of the physical button panel for appropriate rendering the virtual reality environment to include the panel and buttons.

In an embodiment the controller may be a smart phone mounted to headgear to define the headpiece. A software client application provided to the smart phone configures it to be the controller or cooperate with one or more servers to be the controller and to use the smart phone camera as the video camera.

In an embodiment the camera may capture the button panel and finger touches in other than visual light such as infrared.

There is also set forth a method for providing tactile feedback for a user of a virtual reality headpiece viewer is provided including one or more servers for packaging and controlling virtual reality content for delivery to the viewer and for responding to user inputs. A transceiver is provided for delivering the virtual reality content to the viewer and receiving and transmitting inputs from the user to the one or more servers through a communication network. The transceiver may be a wireless transceiver such as a WiFi or broadband communication device and network in communication with the viewer. A video camera is provided for capturing real-time video data of a physical, communicatively inert, button panel and a user's touch at the panel, the touch at the panel providing tactile feedback to the user. A controller receiving the image data transmits the data to the one or more servers via the transceiver where the one or more servers and/or controller synchronize the virtual reality content for defining virtual to substantially to correspond with the positions of one or more physical buttons locations on the physical button panel, define a virtual reality input function to each virtual button and determine a user's touch at a physical button on the panel, generate an input signal associated with the button and its allocated input function and provide the signal to the transceiver for transmission to the one or more servers for controlling an aspect of the virtual reality environment being experienced by the user.

There is also set forth a method for integrating tactile feedback into a player's experience of playing a virtual gaming device using a virtual reality viewer. The method includes accessing, through a transceiver in communication with the viewer, one or more servers which package and control virtual reality gaming content for delivery to the viewer responsive to user inputs. The method includes capturing in real-time video image data of a physical, communicatively inert, button panel positioned for touching by the player to provide tactile feedback as well as capturing images of the player's touches. Receiving the image data a controller transmits the image data to the one or more servers for synchronizing the virtual reality content for defining player observed virtual buttons to substantially coincide with the positions of one or more physical buttons defined on the panel, allocating a virtual reality input function to each virtual button and determining a player's touch at a physical button on the panel for generating an input signal associated with the button and its allocated input function and providing the signal to the transceiver for transmitting to the servers. The viewer controller and/or servers based upon the camera data provide for integration of a view of the physical panel into the virtual reality environment such that the player touching the physical panel obtains the tactile feedback while the camera interprets the touch gesture as an input for controlling one or more feature associated with the virtual reality content.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a virtual reality viewer (VRV) illustrating a view to the user of a portion of a virtual reality (“VR”) rendering of virtual reality content related to a gaming device and physical button panel according to an embodiment of the present invention;

FIG. 2 is top view of an example of a physical button panel suggesting a detectable beacon for registering the virtual reality view of the physical button panel into the virtual reality environment according to an embodiment of the present invention;

FIG. 3 illustrates an example of a system in a casino enterprise for providing communication, processing and support to the VRV according to an embodiment of the present invention;

FIG. 4 illustrates an architecture for a smart phone according to the prior art which can accept a software client application to make it a VRV;

FIG. 5 illustrates a view of a VRV illustrating a view to the user of a portion of a virtual reality content related to a gaming device and cabinet according to an embodiment of the present invention;

FIG. 6 is a view of a player station including a video display, physical, button panel configured to provide tactile/haptic feedback to the user and peripherals according to an embodiment of the present invention;

FIG. 7 is a logic diagram for a controller for the VRV according to an embodiment; and

FIG. 8 illustrates an embodiment of data flows between various applications/services for supporting the game, feature or utility of the present invention for mobile/interactive gaming environment.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of illustrating an embodiment of the invention, it will, unless otherwise indicated, be described with reference to a virtual reality environment for casino games. It should be understood that the invention has utility outside of gaming for environments having user button or other touch inputs to control an aspect of, respond to queries from and provide other inputs relevant to the virtual reality experience of the user for example, button-type inputs where tactile feedback to the user may enhance other computer gaming, publishing, digital photo-processing or other environments susceptible to virtual reality (“VR”) viewing by a viewer.

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. These types of games are sometimes referred to as pay-to-play (P2P) gaming. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). These types of games are sometimes referred to play-for-fun (P4F) gaming. When provided in a social or casual game format, the wagering game may closely resemble a traditional casino game, or it may take another form that more closely resembles other types of social/casual games.

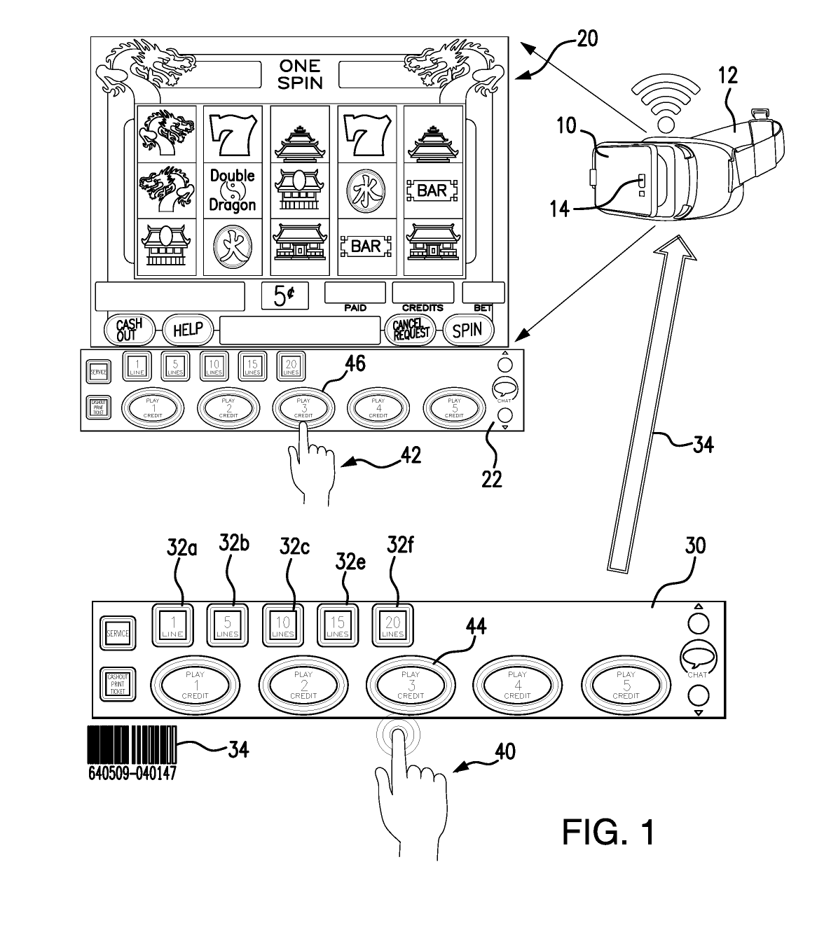

Referring to FIG. 1 and to provide for a user such as a player to interact with VR content there is provided a virtual reality viewer (“VRV”) 10. The VRV 10 includes headgear 12 for holding the VRV 10 on the user's head to position the VRV 10 in front of the user's eyes. In the embodiment shown the VRV 10 is a smart phone retained by the headgear 12 in the proper position with its video display facing the user's eyes for viewing. While not shown the headgear 12 may include eye lenses to be located between the player's eyes and the VRV video display to enhance and/or support the auto-stereo view of the VR content displayed at the VR video display. The VRV 10 also includes a forward looking video camera 14 the purposes of which will be described below. The VRV 10 also includes, in an embodiment, one or more antennae to support wireless communication with a communication network such as WiFi or a cellular telephone network to receive VR content and transmit user inputs. The VRV 10 may take other forms and shapes for providing auto-stereo virtual reality content to a user.

The present invention can also apply to wired networks as well where the VRV 10 is connected by a cable to, for example, a game console, PC computer or the like. In a gaming environment such as a casino where gaming supporting VR content is provided to a VRV 10 provided by or to the player, the communication network will typically be wireless.

As suggested in FIG. 1 the VRV 10 is configured to generate a virtual reality view of a casino environment including a gaming device video display 20 and virtual reality button panel 22. To provide wagering propositions to the player of the VRV 10, VR content is streamed to the VRV 10 over the communication network to generate, as suggested in FIG. 1, an auto-stereoscopic view of the gaming device video display 20 and button panel 22. In an embodiment the virtual gaming device video display 20 and button panel 22 may be a two-dimensional image of the gaming device integrated into the auto-stereo VR environment displayed at the VRV 10. While the VR environment suggested in FIG. 1 shows only the video display 20 and button panel 22, it should be understood that the VR content may create an entire virtual reality, 360° casino environment including visualizations of areas surrounding the gaming device video display 20 such as neighboring gaming devices, active backgrounds and the like. This virtual reality environment may be pre-recorded or generated live by a virtual reality video camera.

The VRV 10 may also include a gyroscope, accelerometer, compass and other devices. Modern smart phones often include these devices. As such the VRV 10 can detect movement, direction and speed of movement of the player's head. To provide the player with an immersive VR experience, the VRV 10 may be controlled to alter the VR view of the player as he/she, turns their head or looks up or down. The VRV 10 provides signals responsive to detecting such movements to one or more VR rendering sources (discussed below) to alter in real-time the VR view experienced by the player. For example, the player viewing the gaming device video display 20 may turn their head to the right resulting in the VR content streaming to the VRV 10 being altered to show a view of neighboring gaming devices, other people, or other scenery. VR cameras can acquire a 360°, live video image at a location such as in front of a gaming machine.

To provide VR content to the VRV 10, the provider may record the VR environment or a portion thereof to be rendered to the player. For example, and with continuing reference to FIG. 1, a casino provider may have one or more prior recorded VR environments for the player to select or for the provider to provide which is mixed with the active, real-time virtual reality view of the gaming device video display 20 and virtual button panel 22. For example, the active and playable VR rendering of the gaming device display 20 and virtual button panel 22 may be overlaid or mixed with a recorded VR environment of other locations in the casino. In another embodiment live VR cameras may acquire real-time, live video of the VR environment to provide to one or more rendering servers to mix with the VR view of the gaming device video display 20 and virtual button panel 22. In an embodiment the VR content could be animated and/or computer generated. Accordingly it should be understood that the VR content is available from one or more sources for delivery to the VRV 10 to provide the user with the VR experience.

As discussed above, it is known to provide for gesture recognition for VRVs such as recognition of hand gestures and finger gestures. In environments where there is no hand-held or hand actuated controller, there are no means or insufficient means for a user to have tactile feedback for inputs such as finger touches or finger slides on buttons. In the illustration of FIG. 1 there is displayed at the VRV 10 the virtual button panel 22 which includes a number of defined buttons each providing a different functional input. In the real world a gaming device would have a physical button panel with, for example, mechanical depressible buttons or video-displayed buttons at a touch screen button panel, to receive the player's input. This input is required for the player to select the wager amount, wager proposition (number of pay lines and amount to bet on each), to prompt play, request service and cash out from the game. When a player touches these real world physical buttons they get tactile feedback from the touch to reinforce to the player that the input has been made. For depressible buttons a finger touch depresses the button in a known fashion to close/open a switch to generate the input which is sent to the game processor to control or set a feature of the game. This touch and button depress is felt by the player. For a touch screen button panel the player touches the panel and that touch is felt to reinforce the input. However in a VR environment where there is no communicative handheld controller or button panel and where instead the system relies upon a gesture in the air captured by the camera for the input, there is no tactile feedback. By “communicative” what is meant is that the handheld controller or keyboard sends input signals to the system for player control purposes. “Communicatively inert” means that the apparatus or device does not communicate with the system for control purposes.

To provide tactile feedback to the player, a physical, communicatively inert, button panel 30 is provided an example of which is shown at FIG. 1. The button panel 30 may include depressible or moveable buttons, be defined by a video touch panel or can simply be printed on paper or other material for laying on a rigid surface. For example, in a casino environment, a player station may be provided for the player to engage in VR gaming as described below. The station would include, for example, a communicatively inert, physical, button panel resting on a platform or table top. The physical button panel 30 may be a silica gel button panel with elastomeric, depressible, buttons or a printed button panel or even a laser or video projected button panel displayed on a rigid surface or a video display with touch screen capability as described below. In any form the physical button panel 30 is configured to provide touch, tactile feedback to the player for touches and finger slides or sliding gestures. The physical button panel 30 defines discrete input buttons, several identified as buttons 32a-e.

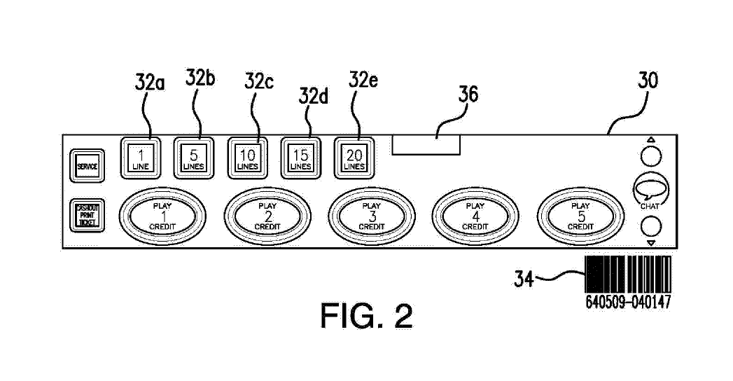

To coordinate the physical button panel 30 with the generated VR environment viewed by the player such as the gaming machine display of FIG. 1, the VRV 10 is adapted to, using the camera 14, capture a view of the physical button panel 30 as suggested by arrow 34 in FIG. 1. For example, when the VR content is initialized for viewing, a message may be presented to the player to dip or move their head until an image of the physical keyboard 30 is captured by the camera 14. To trigger the capture by the camera 14, the physical button panel 30 may include printed or imprinted codes such as bar code 34 or as suggested in FIG. 2, one or more printed markers or glyphs, reflective markers, or one or more powered beacon(s) 36. As but a non-limiting example the beacon 36 may be a powered infrared or visible light beacon 36 which, when the physical button panel 30 is captured by the camera 14 and the beacon 36 is recognized provides a signal to the VRV 10 and/or back end server sources to recognize the physical button panel 30 and to incorporate an a version of the physical button panel 30 into the VR environment content provided to the player. The beacon 36 may emit a code to identify the configuration of the physical button panel 30. A plurality of beacons 36 or markers 34 may be provided for recognition of the type, style size and view of the physical button panel 30. One or more controllers of the VRV 10 and/or back end servers synchronize and incorporate the captured image of the physical button panel 30 into the VR scene as suggested in FIG. 1 where a virtual copy or substantial copy of the physical button panel 30 is rendered as a virtual button panel 22. Movement of the player's head may result in the virtual button panel 22 going out of view; but when the head is tilted the camera 14 again captures its signals to the back end server sources re-render the virtual button panel 22 back into the VR scene.

As can be appreciated to provide tactile feedback to the player, the player touches the communicatively inert physical button panel 30 as shown at 40 (FIG. 1) and the VRV 10 camera 14 captures the touch gesture to provide the corresponding input to control, alter or provide an appropriate input for the VR rendition of the content. The rendition of the VR content at the VRV 10 shows the player's virtual hand at 42 touching the virtual button panel 22 at the location corresponding to the physical touch at 40 of the physical button panel 30. With reference to FIG. 1, the player physical touches physical button 44 on the physical button panel 30 and obtains the tactile feel of the touch and the camera 14 of the VRV 10 captures and interprets the touch gesture as an input for generation of the appropriate input signal as well as generates into the VR content the corresponding visible virtual touch at the virtual button panel 22 at virtually displayed button 46.

The physical button panel 30 can be of any configuration. Where, for example, the physical button is a laser projected button panel projected on a rigid surface, the physical button panel 30 can change based upon the game content being presented. However the button touches are captured by the camera 14 of the VRV 10 and are not, with respect to the VR content, input via the laser projected button panel. That is, the player may wish to play a hypothetical game of “Queen's Treasure” and may so indicate that through their VRV 10. The system would package for delivery to the player the associated VR content and may send a signal through the network to a laser projector to project the corresponding button panel configuration on a rigid surface to define the appropriate physical button panel 30. The VRV 10 captures the laser projected button panel and synchronizes the physical button panel 30 into the VR content for the play of “Queen's Treasure”. The player's touches at the laser projected physical button panel 30 are detected by the camera 14 which interprets the same as an appropriate input.

The acquisition and incorporation of a virtual replica of the physical button panel 30 into the VR content may through augmented reality in a fashion as described in Lyons, et al U.S. Pat. No. 9,269,219 issued Feb. 23, 2016, published Oct. 24, 2013 and titled “System and Method for Augmented Reality with Complex Augmented Reality Video Images” the disclosure of which is incorporated by reference.

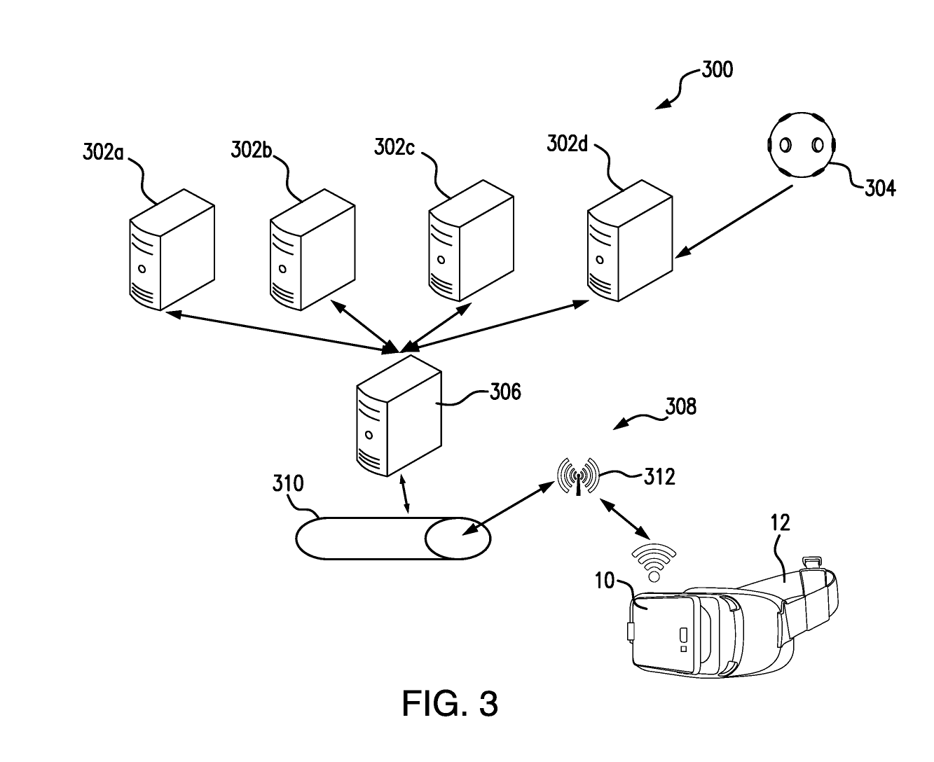

To provide the VR content to the VRV 10 in a casino environment according to an embodiment of the invention the VRV 10 is in communication with a system 300 as illustrated in FIG. 3. To receive, store and configure the VR content the system 300 includes at a content level 301 having one or more configuration and content servers (“CCS”) 302a-d. The one or more CCS 302a-d are configured, in part, to store VRV 10 configuration client software, store or provide access to real-time VR content as well as, in real-time, configure the VR content based upon player inputs and acquisition of other data by the system 300. For example, content server 302d may receive live VR content from a virtual reality camera 304 positioned in a casino. In an embodiment one or more VR cameras 304 may be positioned in a casino to capture a 360° video at one or more locations in a casino environment. This video may be configured and streamed to the VRV 10 to provide the VR environment to the player as described above. In another embodiment the VR video may be saved to a memory such as a DVD or other memory drive for later recall, configuration and delivery to the VRV 10. The CCS 302a-d may store computer generated and/or animated virtual reality video for provision to the VRV 10. The CCS 302a-d are in communication with a delivery and configuration server (“DCS”) 306. DCS 306 may be configured to receive player inputs from the VRV 10, receive virtual reality video either from a stored source or a streaming video source such one or more CCS 302a-d. As described below player stations may be provided to accommodate the player' play using the physical button panel 22 and VRV 10. As illustrated the communication network 308 includes a backbone 310 to provide communication with other systems such as the casino enterprise casino management system, player loyalty system, bonusing systems and the like. A connected backend system may be as disclosed in Kelly et al, US Pub App 2014/0235320A1 filed Apr. 15, 2014 and titled “Dynamic Palpable Controls for a Gaming Device” the disclosure of which has been incorporated by reference. The backbone 310 provides communication to the VRV 10 through a wireless interface 312 which may be a WiFi routers distributed in the casino enterprise or cellular telephone networks. Accordingly the VRV 10 can communicate with the system 300.

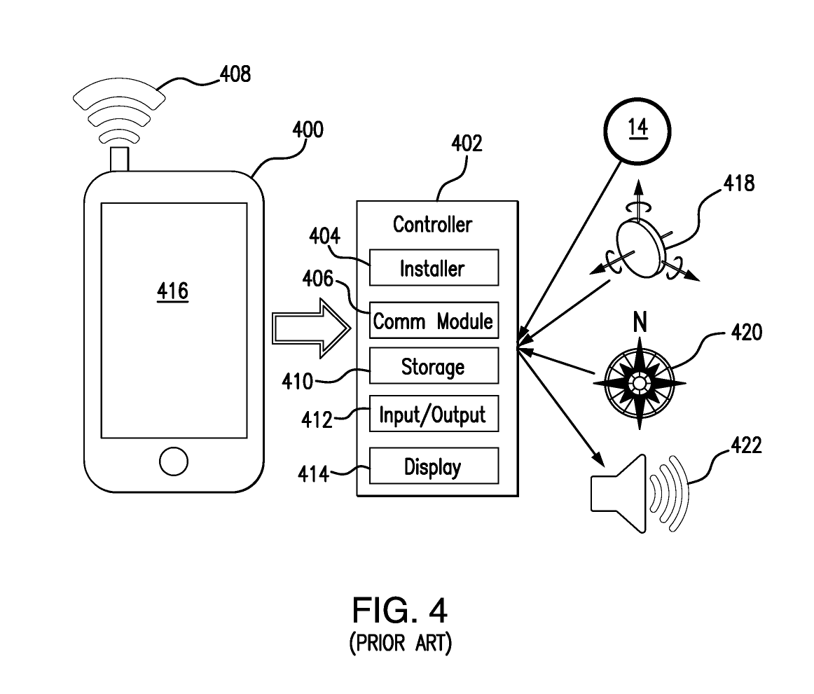

To configure the VRV 10 according to an embodiment of the present invention where the VRV 10 is a player's smart phone, CCS 302a may be configured to store downloadable configuration software client applications adapted to be downloaded by the player for configuring their smart phone device to receive and process data as described herein. During download this software client may also return to CCS 302a data such as data related to the smart phone configuration, e.g. display size and resolution, video camera resolution and capabilities, e.g. infrared enabled, processing capabilities and operating system and accessory links to receive data from the smart phone device such as the camera, gyroscope, compass and accelerometer for determining the view direction and movement of the VRV 10. FIG. 4 illustrates an example of a prior art smart phone architecture such as described in Lee, U.S. Pat. No. 9,100,829 issued Aug. 4, 2015 and titled “Apparatus and Method for Managing Control Information of Application in Portable Terminal” the disclosure of which is incorporated by reference. The smart phone 400 includes a controller 402 having an installer module 404 which manages installation or non-installation of software client applications such one to enable the smart phone 400 to be the VRV 10. The communication module 406 manages communications received/transmitted through the wireless antenna 408 to, for example, receive streaming VR content and transmit player inputs and other data back to the system 300. A storage module 410 stores and manages data, programs, clients and applications stored at the smart phone 400. The input module 412 manages input and output to and from the smart phone 400 and a display module 414 manages the display 416 for the smart phone 400. It should be understood that the controller 402 and various modules described above is not meant to be exhaustive but only illustrative of processing modules for the controller.

The smart phone 400 typically includes peripherals such as the camera 14, a gyroscope 418, compass 420 and speaker 422. Other peripherals such as one or more accelerometers may be provided to determine acceleration associated with the movement of the smartphone 400.

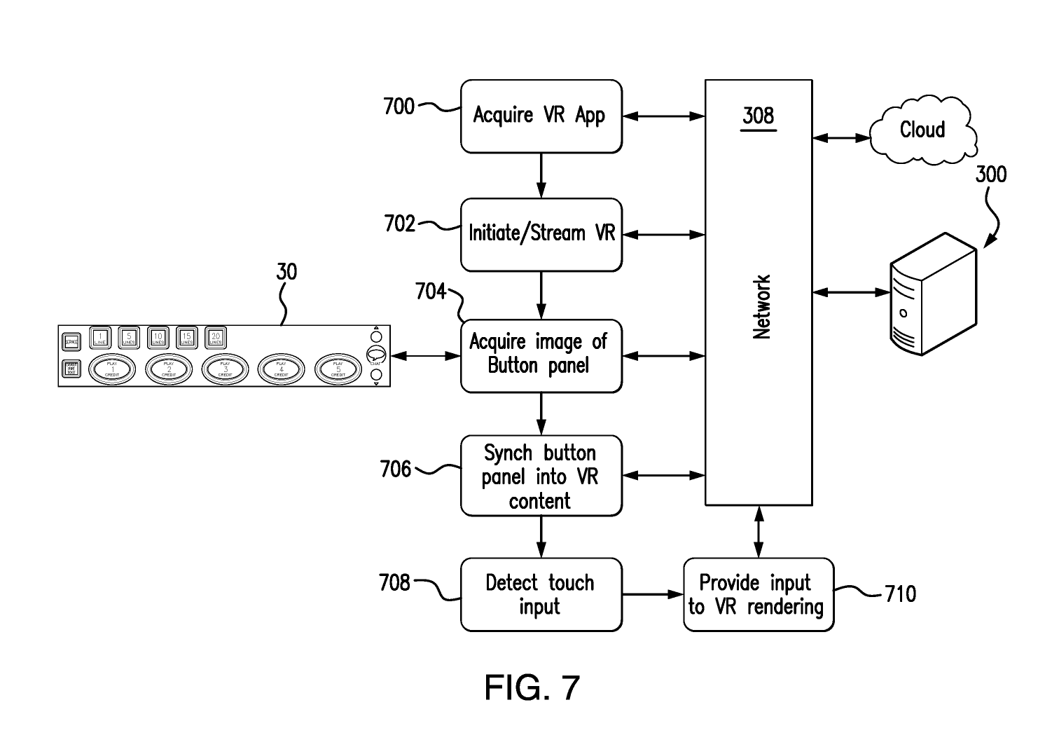

To configure the smart phone 400 into the VRV 10 and with reference to FIG. 7, the player using their smart phone 400 would access the system 300 through a provided web or social media portal to request a configuration software client for VR play of one or more games or other VR content. Where required the player may have to establish an account and provide identification information for purposes such as to prevent underage gaming and get access to the player's electronic fund account(s). In a casino environment the player may establish their credentials including a PIN, age and electronic funds account when they register into the enterprise player loyalty program. Registration may be in person or on line.

The player accesses the system 300 and during the process confirms their credentials and acquires at 700 the appropriate software client application through a download from the CCS 302a to their smart phone 400 to arrange the controller 402 and various modules 404, 406, 410, 412, 414 at the smart phone 400 for configuration as the controller for the VRV 10 to support the features of this invention. As shown in FIG. 7 the download is passed from the system 300 through the communication network 308. Alternatively the controller 402 may be established at the one or more CCS 302a-d to move the bulk of the processing from the smart phone. In still another embodiment the controller 402 may be represented by processing distributed between the smart phone controller 402 and one or more CCS 302a-d. The downloaded software client application configures the controller 402 to enable the VRV 10 to receive streaming VR content for VR viewing, camera 14 acquisition of forward looking video to capture video images of the physical button panel 30 as well as the player's finger, hand gestures or instruments such as a player tracking card, credit card or the like. The controller 402 may require a degree of processing locally at the smart phone now configured as the VRV 10, or the video and input processing may be transmitted for processing to one or more servers 302a-e at the content level 301 or processing may be shared between the VRV 10 and the servers 302a-e. The downloaded client application also configures the controller 402 to process, if some or all of the processing is to occur at the VRV 10 or to forward data to system 300 for some or all of the processing.

At 702 the player launches or initiates the client application to receive VR content. In an embodiment a video instruction may tell the player to move their head such that the VRV 10 camera 14 captures at 704 an image of the physical button panel 30. In an embodiment the controller 402 alone or with processing at the system 300 at 706 synchronizes the view of the physical button panel 30 into the VR content for the gaming device as described with reference o FIG. 1. In an alternate embodiment the video from the camera 14 is transmitted through the network 308 to the system 300 for processing and synchronizing. At this point the player is ready to play the virtually rendered gaming device. By touching the physical button panel 30 or making a gesture the player may access and electronic funds account to transfer funds to establish credits for wagering. In an embodiment described below where the player sits at a player station the player may use a currency or voucher validator to establish wagering credits. The player then touches the physical button panel 30, gets tactile feedback from the touch and at 708 the touches are captured by the camera 14. The controller 402 interprets the touches at 710 as an input to control an aspect of the VR rendering or associated feature. For example the touch may be to select a wager about, prompt a spin, i.e. play of the game, make game selections, cash out or alter their wagers. Where provided the player may also input touch slides or other touch gestures to control an input. The interpreted touches are sent through the network 308 to the system 300 to integrate or alter the rendering of the VR content. For example if the player has selected a minimum wager the VR displayed awards would be according to the lowest wager and the prevailing game pay table.

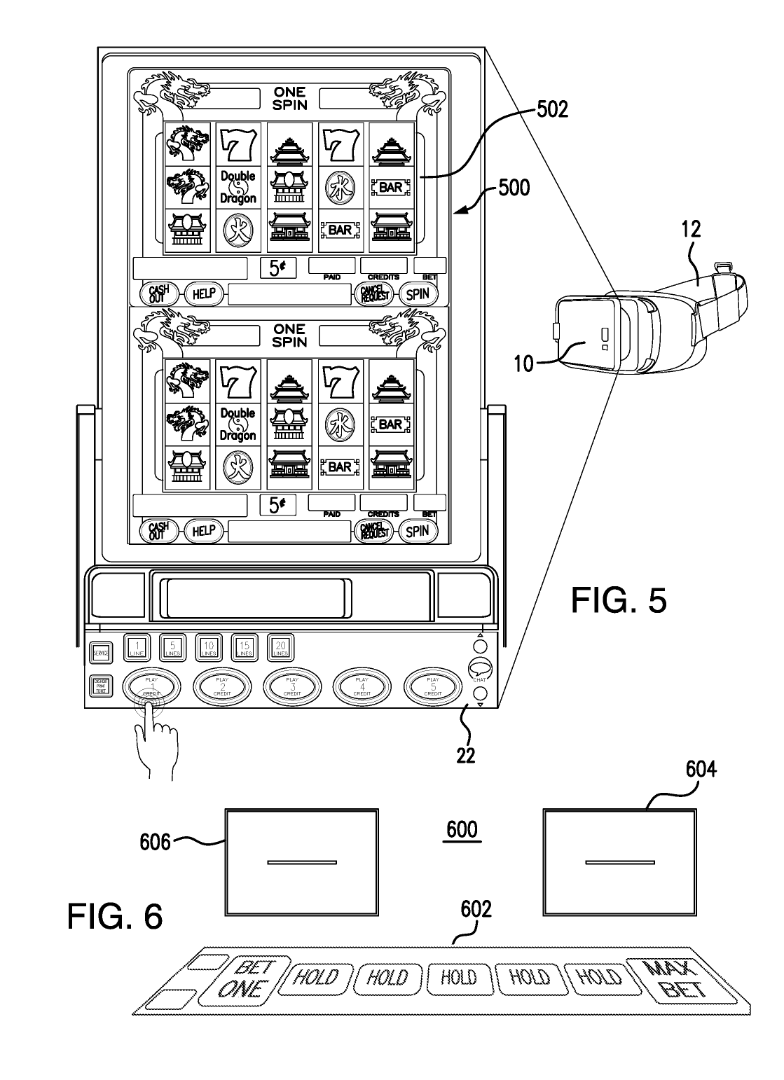

FIG. 5 shows an additional view which may be rendered to the player for play of a virtual gaming machine in a VR environment using a VRV 10. In the embodiment shown the VR content viewed by the player includes the gaming device 500, its cabinet 502 and virtually rendered button panel 22. The VR content for an immersive experience would include, as generated at the VRV 10, surrounding areas and backgrounds such that the player has a 360° view as if he/she were in the casino environment. The controller 402 would detect head movements and directions to alter the VR content accordingly so the player may virtually look around to see other scenery. As discussed above this VR content may be live streamed from an actual casino with the virtual gaming machine graphics rendered and mixed into the VR scene. In an embodiment the mixing is done at the system 300. In an embodiment the VR content and gaming device graphics may be streamed to the VRV 10 and mixed there. In either event the VR content includes the inserted graphics for the play of the gaming device.

To provide the player with a platform to play the virtual reality supported game, as shown in FIG. 6 a casino in a regulated environment may include player stations 600 which includes a physical button panel 602, a player loyalty card reader 604 and a currency/voucher validator 606. The reader 604 represents a player loyalty system interface for reading a player tracking cards as described in Kelly et al, US Pub App 2014/0235320A1 which has been incorporated by reference. The player station 600 would not include the physical gaming machine but instead would rely upon the VR rendition of the gaming machine as described above and may be a physical button panel 30 at a bar top. The card reader 604 and validator 606 would be connected to a supporting network and system. This system may be system 300 or an existing casino management system which interfaces with system 300. When the player inserts their loyalty card into the card reader 604 the player's account is accessed and player tracking may occur. The player's account may also provide access to electronic funds for wagering as well as establish the player's credentials for gaming. The validator 606 provides a resource for the player to load credits into their account as well as cash out accrued credits by receiving a printed voucher. Peltz et al, US Pub App 2016/0012670A1 published Jan. 14, 2016 and titled “ Upright Gaming Machine Having a Dual Chute” the disclosure of which is incorporated by reference discloses a validator which both receives currency and vouches and dispenses cash out vouchers. In the embodiment shown the physical button panel 602 may be a video display button panel as described in Kelly et al, US Pub App 2014/0235320A1 incorporated by reference above.

One or more features of the present invention may be provided to a player who is remotely located from a casino enterprise by an iGaming system for either P2P or P4F gaming. That is a player at home may desire to have a VR gaming experience to play a game for fun wagering virtual credits or, where legal, actually wagering value consideration. FIG. 7 illustrates an exemplary embodiment of information flows in an iGaming environment. At a player level the player or user accesses a site hosting the activity such as a website 800. The website 800 functionally provides a web game client 802. The web game client 802 may be, in an embodiment, represented by a VR game client 808 downloadable at 810 which may process applets transmitted from a gaming server 814 at 811 for rendering and processing game play at a player's remote VRV 10. Where the game is a P2P game the gaming server 814 may process value based wagers, e.g. money wagers, and randomly generate an outcome for rendition at the player's device. In an embodiment the web game client 802 may access a local memory store to drive the VR display at the player's VRV 10. In another embodiment all or a portion of the game graphics may be streamed to the player's VRV 10 with the web game client 802 enabling player interaction and display of game features and outcomes at the player's device.

The website 800 also accesses a player-centric iGaming platform level account module 804 at 806 for the player to establish and confirm credentials for play and, where permitted, access an electronic funds account (eWallet) for wagering. The account module may include or access data related to the player profile (player-centric information desired to be retained and tracked by the host), the player's eWallet and deposit and withdrawal records, registration and authentication information such as username and password, name and address information, date of birth, a copy of a government issued identification document such as a driver's license or passport and biometric identification criteria such as fingerprint, facial recognition data) and a responsible gaming module containing information such as self-imposed (or jurisdictionally imposed) gaming restraints such as loss limits, daily limits and duration limits. The account module 804 may also contain and enforce geo-location limits such as geographic areas where the player may play P2P games, user device IP address confirmation and the like.

The account module 804 communicates at 805 with a game module 816 for completing log-ins, registrations and other activities. The game module 816 may also store or access a player's gaming history such as player tracking and loyalty club account information. The game module 816 may provide static web pages to the VRV 10 from the game module 816 through line 818 whereas, as stated above, the live VR content is provided from the gaming server 814 to the web game client through line 811.

The VR game server 814 is configured to provide interaction between the game and the player such as receiving wager information, game selection, button interaction gesture recognition, inter-game player selections or choices to play a game to its conclusion and well the random selection of game outcomes and graphics packages which, alone or in conjunction with the downloadable game client 808/web game client 802 and game module 816 provide for the display of game graphics and player interactive interfaces. At 818 player account and log-in information is provided to the gaming server 814 from the account module 804 to enable gaming. 820 provides wager/credit information between the account module 804 and gaming server 814 for the play of the game and may display credits/eWallet availability. 822 provides player tracking information for the gaming server 814 for tracking the player's play. The tracking of play may be used for purposes of providing loyalty rewards to a player, determining preferences and the like.

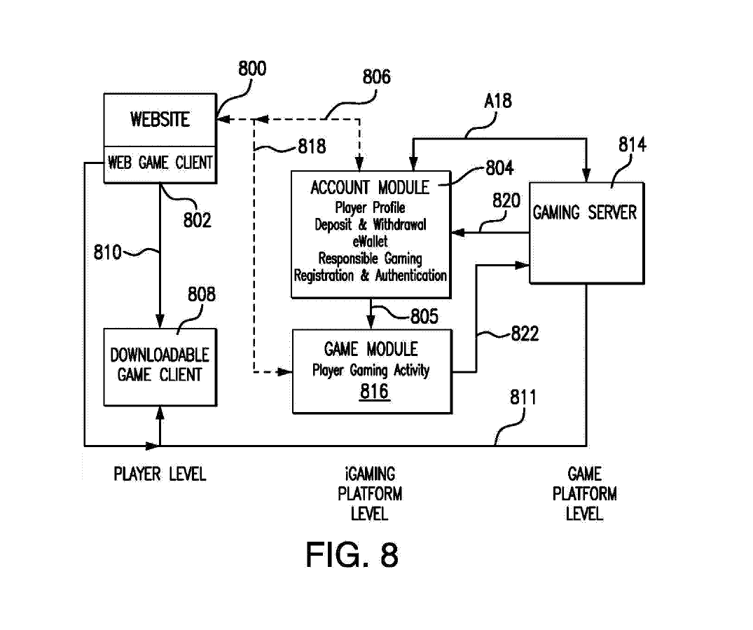

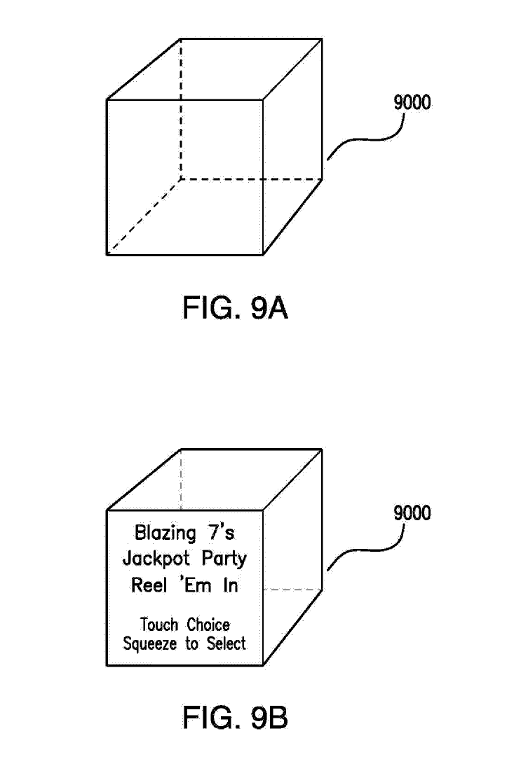

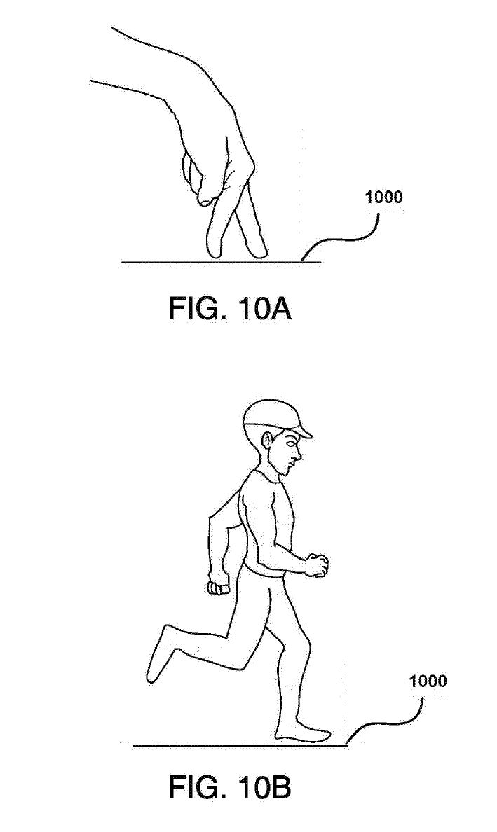

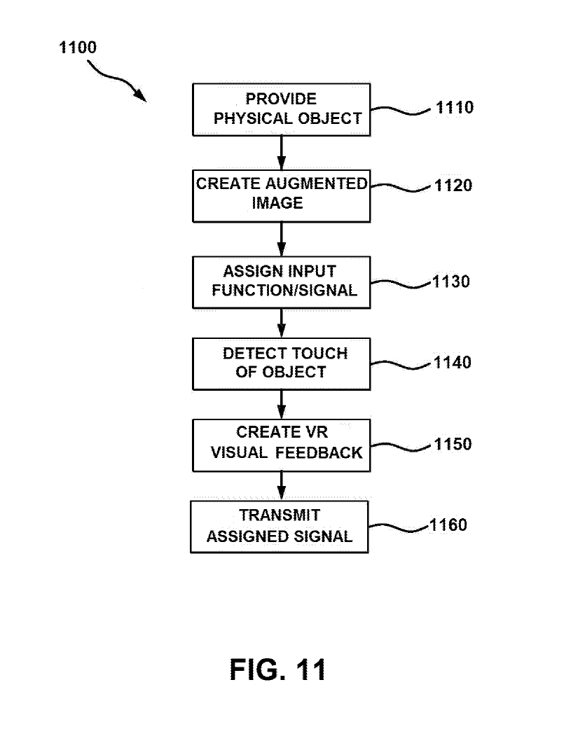

All or portions of the features of FIG. 8 may be supported by servers and databases located remotely from a player's VRV 10 and may be hosted or sponsored by regulated gaming entity for P2P gaming or, where P2P is not permitted, for entertainment only play.

In a further embodiment where a player at a physical gaming machine would like to continue gaming elsewhere in the casino in a VR environment, the player may elect to move the game being played for play using the VRV 10 at another location such as a player station 600 in a bar or restaurant. This may be advantageous where, for example, the casino venue is limited to a number of gaming machines. The player using their smart phone 400 would go through the steps to transfer the game to the mobile device such as disclosed in Hedrick et al, US Pub App 2015/0228153A1 published Aug. 13, 2015 and titled “System and Method for Remote Control Gaming Sessions Using a Mobile Device” the disclosure of which is incorporated by reference. The system 300 recognizes the request to transfer and thereafter moves the game experience to a VR experience as described above.

The acquisition of the physical button panel 30 for integration into the VR content may be through augmented reality technology as described in Lyons, et al U.S. Pat. No. 8,469,260 issued Jun. 25, 2013 and titled “System and Method for Assisted Maintenance in a Gaming Machine Using a Mobile Device” the disclosure of which is incorporated by reference. The player with the VRV 10 camera 14 acquires a video of the physical button panel 30 and in an embodiment the bar code 34. The controller 402 and/or system 300 receive the video data and use that information to overlay function graphics for the buttons.

A generic physical input device other than a button panel may take the form of a compressible ball or a cube or other multi-faceted object that fits in the player's hand. For example, the object may be constructed of foam or rubber. The object can be squeezed and released, acting as button, when the camera 14 of VRV 10 detects the player's hand so acting on the object. In some embodiments, the blank object (as illustrated in FIG. 9A) may be augmented in the virtual world, such as overlaid with a menu of player selections (as shown in FIG. 9B). Other instructions related to use of the object may be overlaid depending on the current state of the game being played.

The above examples of buttons and a button panel may be extended to any number of tangible physical objects which are also within the scope of the various embodiments of the invention. One example of a VR game which may be made available in accordance with one or more embodiments of a system as described by FIG. 8 or the steps of FIG. 7 is a virtual card game with rules such as Texas Hold'em or Blackjack. Each player, playing in a location such as in their own home, provides basic tactile-feedback game supplies such as a chair, a table, two playing cards of any kind and a certain number of tokens or chips. In such a multiplayer environment, each participating player has the same kind of physical equipment, though only the set of the equipment belonging to a certain player may be in use at a given time. The virtual game combines the “scene” from each of the players to represent a single common VR table with avatars for the players, renderings of the physical chips and cards in front of each player, etc.

As described above with respect to buttons, the camera 14 of VRV 10 acquires a video of each physical object and its orientation on the table or in each player's hands. The controller 402 and/or system 300 receive the video data and use that information to overlay values on the cards and chips, position an avatar of each player around a virtual table and mimic their movements, etc. The values of the playing cards do not matter, nor does the color of the chips, the size of the table, etc. The inclusion of the physical objects in play of the game provides individualized tactile feedback to each player while playing a virtual game presented on the VRV 10. Once the objects are detected, the system overlays all relevant markings, such as backs and rank and suit, on the cards and colors or values on the chips according to their orientation in physical space. For example, if a card is face up, its face is shown. If not, its back is shown. Similarly, if a player “peeks” at his physical cards by lifting physically lifting up a corner, tucks his cards under his chips to signal “staying” in Blackjack, moves one or more chips into a betting circle or the like, these actions will be represented in the virtual world via that player's presentation on the VRV 10 and also in the virtual worlds of any other players of the game.

In accordance with one or more embodiments, system 300 can also detect if any of the required objects is missing and suspend game play until all required objects are provided and ready for use. Similarly, some embodiments may require the placement of certain objects in certain locations in order for game play to start or continue. For example, the game may direct a player to place his two playing cards in a space marked by a rectangle or to place one of his chips in an ante circle depicted by VRV 10.

In accordance with still other embodiments, a single die or two or more dice may be used. Again, the player has dice he can physically hold, shake and throw in order to provide tactile feedback to his VR game. The VRV 10 tracks the dice on a tabletop or floor and represents their location on its display so they can be picked up again by the player. As with the card example above, when the player throws the dice, the face that actually lands upright is irrelevant as the image provided in the virtual world will show the outcome determined by the game engine. In accordance with some embodiments, to avoid having to track the dice and have them be picked up by the player, they may be in sealed cup. When it is time to roll the dice, the player can still shake and feel the dice in the cup, but when the player makes a throwing motion, the virtual dice appear thrown while the physical dice remain in the cup. The cup is next used when it is time to throw the dice again.

In accordance with one or more embodiments, a floor space may become a source of feedback for the player. If a player has an open floor space available in a room, camera 14 of VRV 10 captures an image of the space and determines its size in order to determine a scale usable in the virtual scene. The floor space then becomes akin to a touchscreen surface and the location of the player's feet within the space determines where a “touch” occurs. For example, in a game of virtual roulette, the player may not be sitting at table but, instead, be represented as an avatar in a large virtual world who can walk around on the betting layout, placing wagers or issuing commands with his feet by stepping on virtual buttons portrayed by the VRV 10. A selection or wagering action, for example, may occur if the player jumps up and down, taps his foot, etc. In these cases, the input signal includes not only an activation signal, but position information, such as x-, y- and z-coordinates, as well, all of which may be combined by the system in evaluating the nature of the input.

Similarly, in accordance with still other embodiments, a surface such as a blank tabletop provided by the player can become the scene for a 3D world portrayed by the VRV 10. The player can walk around edges of the table and see the virtual world or game from different perspectives. In accordance with still other embodiments, the tabletop may also serve as a touchscreen over which the player can “walk” around the surface 1000 of the game space with his fingers, as shown in FIG. 10A, placing bets or moving around the virtual space. His hand and fingers may be replaced by an avatar standing on surface 1000 in the virtual reality space, as illustrated in FIG. 10B. Each press of a finger on the surface provides tactile feedback to the player and visual detection by the system provides position and any other input signal information.

Alternately, the player may stay in place and, by using hand gestures or pressing virtual controls on the surface of the table, rotate or otherwise alter the presentation of the table in order to view it from different angles. In some embodiments, a haptic feedback pad may be placed on the table to provide additional feedback when dice, cards, chips and the like hit the table.

A VR game may use existing buttons and controls on an existing device such as a gaming machine. At various points in the VR game, more controls than are provided by the existing device may be required and ask a player to dynamically assign objects he can feel and also see in the rendered scene as the new controls. For example, an extra button may be required. In accordance with one or more embodiments, the game may ask the player to select a visible object that he can also feel for use as the button or control. The VRV 10 may display portions of the player's body visible to camera 14, such as his wrist, and the player may select the face of his wristwatch as the additional control. During the game, any time the player touches the face of his wristwatch, the control is activated. Similarly, various surfaces on the gaming machine itself may be selected. In another non-limiting example, the player may elect to use the center top edge of gaming machine cabinet 502 as a control. Again, during the game, any time the camera 14 of VRV 10 detects the player touching the center top edge of the gaming machine cabinet, the control is activated.

In accordance with some embodiments, the VR game may assign certain unused spaces on a physical device such as a physical button panel 602 or gaming machine cabinet 502 and, using augmented reality, overlay the new control in that space. When the player touches the overlaid control, the underlying surface provides tactile feedback that the additional control has been touched.

FIG. 11, in accordance with one or more embodiments, represents another example of an algorithm 1100 to perform the tactile feedback functions associated with the above disclosed concepts that corresponds to at least some instructions stored and executed by a VR system including a virtual reality headpiece viewer and one or more servers to package and control virtual reality content delivered to the user responsive to user inputs and a transceiver to deliver the content to the viewer and receive and transmit inputs from the user to the one or more servers through a communication network.

At block 1110 of FIG. 11, a palpable physical object associable with at least one user input is provided. A user touch of the object provides a tactile feedback to the user. As described above, the physical object may be, but is not limited to, one of a button, a button panel, a die or dice, one or more playing cards, one or more chips or coins, a tabletop surface, a floor surface or any other object or surface visually detectable by the VR system and within reach of the user. As also noted above, the user may dynamically designate any tangible object detectable by a camera of the VR system and rendered by that system in his virtual surroundings as the physical object or a physical object. In other embodiments, the system may dynamically designate such as object as a supplemental control. In some embodiments, the physical object may be part of a set of objects required for use in a game.

In accordance with some embodiments, the viewer includes position sensors to detect when the user's field of view includes the physical object. In these cases; the optional step of generating an augmented image of the physical object to, from the user's viewpoint, overlay one or more images on a live image of the physical object, is performed at block 1120.

At block 1130, since the physical object does not provide any signal to the one or more servers responsive to a touch by the user, a virtual reality system input function and a signal corresponding to a detected touch of the object is assigned.

At block 1140, the camera captures real-time image data corresponding to the user's touch of the physical object determined in block 1110 and the image data is sent to and received by the system's server(s) for processing at block 1150.

At block 1150, the user's touch of the physical object is synchronized with a generated virtual reality image corresponding to the touch of the object to provide visual feedback to the user. As noted above, tactile feedback to the user is provided by the physical object itself

Finally, at block 1160, the signal assigned in block 1130 is provided to the transceiver and sent to the server.

The order of actions as shown in FIG. 11 is only illustrative, and should not be considered limiting. For example, the order of the actions may be changed, additional steps may be added or some steps may be removed without deviating from the scope and spirit of the invention.

While the above invention has been described with reference to a gaming environment, it has applications to VR users in other environments where touch feedback would be advantageous. For example, at home, a user may want to engage in online banking or other eCommerce activity. They would print a physical button panel and acquire the client application for providing the VR environment. The user could virtually walk through a store or mall and use the buttons, supported by tactile feedback, to make selections.

Each of these embodiments and obvious variations thereof is contemplated as falling within the spirit and scope of the claimed invention, which is set forth in the following claims. Moreover, the present concepts expressly include any and all combinations and sub combinations of the preceding elements and aspects.

What is claimed is:

1. A system for providing tactile feedback for a user of a virtual reality viewer, the system including one or more servers to package and control virtual reality content delivered to the viewer responsive to user inputs and a transceiver to deliver the content to the viewer and receive and transmit inputs from the user to the one or more servers through a communication network, the system comprising:
a tangible object associable with at least one user input, a user's touch of the object providing a tactile feedback to the user, the physical object not providing any signal to the one or more servers responsive to the touch by the user;
a video camera to capture real-time image data corresponding to the user's touch of the tangible object;
a controller to allocate a virtual reality input function for the object, receive the image data and (i) synchronize a physical touch of the object with a generated virtual reality image corresponding to a touch of the object, (ii) allocate a virtual reality input function and corresponding signal to the touch of the object and (iii) provide the signal to the transceiver.

2. The system of claim 1 wherein the viewer includes at least one position sensor to detect when a field of view of the user includes the tangible object wherein the controller is configured to generate an augmented reality image of the object to, from the user's viewpoint, overlay one or more images on the object.

3. The system of claim 1 wherein the tangible object comprises visually defined positions to be associated with a plurality of different user inputs each having an associated virtual reality input function and corresponding signal, the controller configured to synchronize the virtual reality images to the visually defined positions and to detect from the image data a touch of one of the visually defined positions to provide its associated signal.

4. The system of claim 1 wherein the tangible object is compressible and the user's touch comprises compressing the object.

5. The system of claim 1 wherein the user's touch comprises pressing upon the object.

6. The system of claim 1 wherein the tangible object comprises a depressible button.

7. The system of claim 1 wherein the user's touch comprises moving the object.

8. The system of claim 1 wherein the object comprises a flat surface and wherein the input signal comprises a location of the user's touch on the object.

9. The system of claim 8 wherein the flat surface further comprises a haptic feedback device.

10. The system of claim 1 wherein the tangible object is selectable by the user from a set of objects viewable via the virtual reality viewer.

11. The system of claim 1 wherein the tangible object is dynamically assigned by the controller from a set of objects detectable by a camera of the system.

12. The system of claim 1 wherein at least a portion of the body of the user is depicted by the virtual reality viewer.

13. The system of claim 1 wherein the user is depicted by the virtual reality viewer as an avatar and wherein the user's touch affects the depiction of the avatar.

14. A system for providing tactile feedback for a user of a virtual reality viewer for playing a virtual gaming device, the system including one or more servers to package and control virtual reality gaming content delivered to the viewer responsive to user inputs and a transceiver to deliver the content to the viewer and receive and transmit inputs from the user to the one or more servers through a communication network, the system comprising:
a physical button panel for buttons associable with different user inputs, the user's touch at a button providing a tactile feedback to the user, the panel not providing any signal to the one or more servers responsive to a button touch;
a video camera to capture real-time image data corresponding to the user's touch at the button panel;
a controller to allocate a virtual reality input function for the buttons, receive the image data and (i) synchronize a physical touch at the panel with a generated virtual reality image corresponding to a touch of the button, (ii) allocate a virtual reality input function and corresponding output signal to the touch of the button and (iii) provide the signal to the transceiver.

15. The system of claim 14 wherein the viewer includes position sensors to detect when the user's field of view includes the tangible object wherein the controller is configured to generate an augmented reality image of the object to, from the user's viewpoint, overlay one or more images on the object.

16. A method for providing tactile feedback to a user of a virtual reality viewer via a system including one or more servers to package and control virtual reality content delivered to the viewer responsive to user inputs and a transceiver to deliver the content to the viewer and receive and transmit inputs from the user to the one or more servers through a communication network, the method comprising:
providing a tangible object associable with at least one user input, a user's touch of the object providing a tactile feedback to the user, the physical object not providing any signal to the one or more servers responsive to the touch by the user;
capturing, with a camera, real-time image data corresponding to the user's touch of the physical object;
receiving the image data;
synchronizing image data representing the touch of the physical object with a generated virtual reality image corresponding to the touch of the object;
allocating a virtual reality input function and corresponding signal to the touch of the object; and
providing the signal to the transceiver.

17. The method of claim 16 wherein the viewer includes one or more position sensors to detect when the user's field of view includes the tangible object; and comprising the step of generating a virtual reality image of the physical object to, from the user's viewpoint, overlay one or more images on the physical object.

18. The method of claim 16 wherein the tangible object is compressible and the user's touch comprises compressing the object.

19. The method of claim 16 wherein the user's touch comprises pressing upon the object.

20. The method of claim 16 wherein the object comprises a flat surface and wherein the input signal comprises a location of the user's touch on the object.
